(19) United States
(12) Patent Application Publication
(10) Pub. No.: US 2008/0208578 A1
(43) Pub. Date: Aug. 28, 2008

(54) Robust Speaker-Dependent Speech Recognition System

(75) Inventor: Dieter Geller, Aachen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,703

(22) PCT Filed: Sep. 13, 2005
(86) PCT No.: PCT/IB05/52986

§ 371 Date: Mar. 21, 2007

(30) Foreign Application Priority Data
Sep. 23, 2004 (EP) 04104627.7

(51) Int. Cl. G10L 15/06

(52) U.S. Cl. 704/243

(57) ABSTRACT

The present invention provides a method of incorporating speaker-dependent expressions into a speaker-independent speech recognition system providing training data for a plurality of environmental conditions and for a plurality of speakers. The speakerdependent expression is transformed in a sequence of feature vectors and a mixture density of the set of speaker-independent training data is determined that has a minimum distance to the generated sequence of feature vectors. The determined mixture density is then assigned to a Hidden-Markov-Model (HMM) state of the speaker-dependent expression. Therefore, speaker-dependent training data and references no longer have to be explicitly stored in the speech recognition system. Moreover, by representing a speaker-dependent expression by speaker-independent training data, an environmental adaptation is inherently provided. Additionally, the invention provides generation of artificial feature vectors on the basis of the speaker-dependent expression providing a substantial improvement for the robustness of the speech recognition system with respect to varying environmental conditions.

The present invention relates to the field of speech recognition systems and in particular without limitation to a robust adaptation of a speech recognition system to varying environmental conditions.

Speech recognition systems transcribe a spoken dictation into written text. The process of text generation from speech can typically be divided into the steps of receiving a sound signal, pre-processing and performing a signal analysis, recognition of analyzed signals and outputting of recognized text.

The receiving of a sound signal is provided by any means of recording, as e.g. a microphone. In the signal analyzing step, the received sound signal is typically segmented into time windows covering a time interval typically in the range of several milliseconds. By means of a Fast Fourier Transform (FFT) the power spectrum of the time window is computed. Further, a smoothing function with typically triangle shaped kernels is applied to the power spectrum and generates a feature vector. The single components of the feature vector represent distinct portions of the power spectrum that are characteristic for content of speech and therefore ideally suited for speech recognition purpose. Furthermore a logarithmic function is applied to all components of the feature vector resulting in feature vectors of a log-spectral domain. The signal analysis step may further comprise an environmental adaptation as well as additional steps, as e.g. applying a cepstral transformation or adding derivatives or regression deltas to the feature vector.

In the recognition step, the analyzed signals are compared with reference signals derived from training speech sequences that are assigned to a vocabulary. Furthermore, grammar rules as well as context dependent commands can be performed before the recognized text is outputted in a last step.

Environmental adaptation is an important step of the signal analysis procedure. In particular, when the trained speech references were recorded with a high signal to noise ratio (SNR) but the system is later on applied in a noisy environment, e.g. in a fast driving car, the performance and reliability of the speech recognition process might be severely affected, because the trained reference speech signal and the recorded speech signal that has to be recognized feature different levels of a background noise and hence feature a different SNR. Variations of the signal to noise ratio during a training procedure and the application of the speech recognition system is only one example of an environmental mismatch. Generally, a mismatch between environmental conditions might be due to various background noise levels, various levels of inputted speech, various speech velocity and due to different speakers. In principle, any environmental mismatch between a training procedure and an application or recognition procedure may severely degrade the performance of the speech recognition.

The concept of speaker-independent speech recognition provides a general approach to make an automatic speech recognition versatile. Here, the pre-trained speech references are recorded for a large variety of different speakers and different environmental conditions. Such speaker-independent speech recognition references allow a user to directly apply an automatic speech recognition system without performing a training procedure in advance.

However, also such an application mainly intended for speaker-independent speech recognition might need further training. In particular, when the system has to recognize a user specific expression, such as a distinct name that the user wants to insert into the system. Typically, the environmental conditions in which a user enters a user or speaker-dependent expression into the automatic speech recognition system differs from the usual recognition condition later on. Hence, the trained speech references may feature two separate parts, one that represents speaker-independent references and one that represents speaker-dependent references. Since the speaker-dependent references are typically only indicative of a single user and a single environmental condition, the general performance of the speech recognition procedure may deteriorate appreciably.

The speaker-dependent words may only be correctly identified when the recognition conditions correspond to the training conditions. Furthermore, a mismatch between the training conditions for the speaker-dependent words and the conditions in which the automatic speech recognition system is used may also have a negative impact on the recognition of speaker-independent words.

In general, there exist various approaches to incorporate speaker-dependent words into a set of speaker-independent vocabulary words. For example, the speaker-dependent vocabulary word can be trained under various environmental conditions, such as in a silent standing car and in a fast driving car. This may provide a rather robust speech recognition but requires a very extensive training procedure and is therefore not acceptable for an end user.

Another approach is provided by e.g. U.S. Pat. No. 6,633,842 disclosing a method to obtain an estimate of clean speech feature vector given its noisy observation is provided. This method makes use of two Gaussian mixtures wherein the first is trained off-line on cleaned speech and the second is derived from the first one using some noise samples. This method gives an estimate of a clean speech feature vector as the conditional expectancy of clean speech given an observed noisy vector. This method uses the estimation of clean feature vector from noisy observation and probability density function.

In principle, this allows performance improvement but the noise sample has to be provided and to be combined with the cleaned speech, thereby inherently requiring appreciable computation and storage capacity.

The present invention therefore aims to provide a method of incorporating speaker-dependent vocabulary words into a speech recognition system that can be properly recognized for a variety of environmental conditions without explicitly storing speaker-dependent reference data.

The present invention provides a method of training a speaker-independent speech recognition system with the help of spoken examples of a speaker-dependent expression. The speaker-independent speech recognition system has a database providing a set of mixture densities representing a vocabulary for a variety of training conditions. The inventive method of training the speaker-independent speech recognition system comprises generating at least a first sequence of feature vectors of the speaker-dependent expression and determining a sequence of mixture densities of the set of mixture densities featuring a minimum distance to the at least first sequence of feature vectors.

Finally, the speaker-dependent expression is assigned to the sequence of mixture densities. In this way, the invention provides assignment of a speaker-dependent expression to mixture densities or a sequence of mixture densities of a speaker-independent set of mixture densities representing a vocabulary for a variety of training conditions. In particular, assignment of the mixture densities to the speaker-dependent expression is performed on an assignment between the mixture density and the at least first sequence of feature vectors representing the speaker-dependent expression.

This assignment is preferably performed on a feature vector based assignment procedure. Hence, for each feature vector of the sequence of feature vectors, a best matching mixture density, i.e. the mixture density providing a minimum distance or score to the feature vector, is selected. Each feature vector is then separately assigned to its best matching mixture density by means of e.g. a pointer to the selected mixture density. In this way, the sequence of feature vector can be represented by a set of pointers, each of which pointing from a feature vector to a corresponding mixture density.

Consequently, a speaker-dependent expression can be represented by mixture densities of speaker-independent training data. Hence, speaker-dependent reference data does not have to be explicitly stored by the speech recognition system. Here, only an assignment between the speaker specific expression and a best matching sequence of mixture densities, i.e. those mixture densities that feature a minimum distance or score to the feature vectors of the at least first sequence of feature vectors, is performed by specifying a set of pointers to the mixture densities that already exists in the database of the speaker-independent speech recognition system. In this way the speaker-independent speech recognition system can be expanded to a large variety of speaker-dependent expressions without the necessity of providing dedicated storage capacity for the speaker-dependent expressions. Instead, speaker-independent mixtures are determined that sufficiently represent the speaker-dependent expression.

According to a preferred embodiment of the invention, the method of training the speaker-independent speech recognition system further comprises generating at least a second sequence of feature vectors of the speaker-dependent expression. This at least second sequence of feature vectors is adapted to match a different environmental condition than the first sequence of feature vectors. Hence, this second sequence of feature vectors artificially represents a different environmental condition than the environmental condition for which the speaker-dependent expression has been recorded and being reflected in the first sequence of feature vectors. The at least second sequence of feature vectors is typically generated on the basis of the first sequence of feature vectors or directly on the basis of the recorded speaker-dependent expression. For example, this second sequence of feature vectors corresponds to the first sequence of feature vectors with a different signal to noise ratio. This second sequence of feature vectors can for example be generated by means of a noise and channel adaptation module providing generation of a predefined signal to noise ratio, a target signal to noise ratio.

The generation of artificial feature vectors or sequences of artificial feature vectors from the first sequence of feature vectors is by no means restricted to noise and channel adaptation and to generation of only a single artificial feature vector or a single sequence of artificial feature vectors. For example, based on the first sequence of feature vectors, a whole set of feature vector sequences can be artificially generated, each of which representing a different target signal to noise ratio.

According to a further preferred embodiment of the invention, generation of the at least second sequence of feature vectors is based on a set of feature vectors of the first sequence of feature vectors that corresponds to a speech interval of the speaker-dependent expression. Hence, generation of artificial feature vectors is only performed on those feature vectors of the first sequence of feature vectors that correspond to speech frames of the recorded speaker-dependent expression. This is typically performed by an endpoint detection procedure determining at which frames the speech part of a speaker-dependent training utterance starts and ends. In this way, those frames of a training utterance that represent silence are discarded for the generation of artificial feature vectors. Hence, the computational overhead for artificial feature vector generation can be effectively reduced. Moreover, by extracting feature vectors of the first sequence of feature vectors representing speech, also the general reliability and performance of assignment of the at least first sequence of feature vectors to the speaker-independent mixture density can be enhanced.

According to a further preferred embodiment of the invention, the at least second sequence of feature vectors can be generated by means of a noise adaptation procedure.

In particular, by making use of a two-step noise adaptation procedure the performance of the general speech recognition is typically enhanced for speech passages featuring a low SNR.

In a first step various feature vectors are generated on the basis of an originally obtained feature vector, each of which featuring a different signal to noise ratio. Hence, different noise levels are superimposed on the original feature vector. In a second step the various artificial feature vectors featuring different noise levels become subject to a de-noising procedure which finally leads to a variety of artificial feature vectors having the same target signal to noise ratio. By means of such a two-step process of noise contamination and subsequent de-noising the various artificial feature vectors can be effectively combined and compared with stored reference data. Alternatively, artificial feature vectors may also be generated on the basis of spectral subtraction, which is rather elaborate and requires a higher level of computing resources than the described two-step noise contamination and de-noise procedure.

According to a further preferred embodiment of the invention, the at least second sequence of feature vectors is generated by means of a speech velocity adaptation procedure and/or by means of a dynamic time warping procedure. In this way, the at least second sequence of feature vectors represents an artificial sequence of feature vectors having a different speech velocity than the first sequence of feature vectors. In this way a speaker-dependent expression can be adapted to various levels of speech velocity. Therefore, also a large diversity of speakers can be emulated whose speech has a different spectral composition and features a different speech velocity.

Additionally, the at least second sequence of feature vectors might be representative of a variety of different recording channels, thereby simulating a variety of different technical recording possibilities that might be due to an application of various microphones. Moreover, artificial generation of the at least second sequence of feature vectors on the basis of the recorded first sequence of feature vectors can be performed with respect to the Lombard effect representing a non-linear distortion that depends on the speaker, the noise level and a noise type.

According to a further preferred embodiment of the invention, the at least first sequence of feature vectors corresponds to a sequence of Hidden-Markov-Model (HMM) states of the speaker-dependent expression. Moreover, the speaker-dependent expression is represented by the HMM states and the determined mixture densities are assigned to the speaker-dependent expression by assigning the mixture densities to the corresponding HMM states. Typically, the first sequence of feature vectors is mapped to HMM states by means of a linear mapping. This mapping between the HMM state and the feature vector sequence can further be exploited for the generation of artificial feature vectors. In particular, it is sufficient to generate just those feature vectors from frames that are mapped to a particular HMM state in the linear alignment procedure. In this way generation of artificial feature vectors can be effectively reduced.

According to a further preferred embodiment of the invention, determination of the mixture densities having a minimum distance to the feature vectors of the at least first sequence of feature vectors effectively makes use of a Viterbi approximation. This Viterbi approximation provides the maximum probability instead of the summation over probabilities that a feature vector of the at least first set of feature vectors can be generated by means of one constituent density of the set of densities that the mixture consists of. Determination of the mixture density representing a HMM state might then be performed by making use of calculating an average probability that the set of artificially generated feature vectors belonging to this HMM state, can be generated by this mixture comprising a geometric average of maximum probabilities of the corresponding feature vectors. Moreover, the minimum distance for a mixture density can be effectively determined by using a negative logarithmic representation of the probability instead of using the probability itself.

According to a further preferred embodiment of the invention, assigning of the speaker-dependent expression to a sequence of mixture densities comprises storing of a set of pointers to the mixture densities of the sequence of mixture densities. The set of mixture densities is inherently provided by the speaker-independent reference data stored in the speech recognition system. Hence, for a user specified expression no additional storage capacity has to be provided. Only the assignment between a speaker-dependent expression represented by a series of HMM states and a sequence of mixture densities featuring a minimum distance or score to these HMM states has to be stored. By storing the assignment in form of pointers instead of explicitly storing speaker-dependent reference data, the requirement for storage capacity of a speech recognition system can be effectively reduced.

In another aspect, the invention provides a speaker-independent speech recognition system that has a database providing a set of mixture densities representing a vocabulary for a variety of training conditions. The speaker-independent speech recognition system is extendable to speaker-dependent expressions that are provided by a user. The speaker-independent speech recognition system comprises means for recording a speaker-dependent expression that is provided by the user, means for generating at least a first sequence of feature vectors of the speaker-dependent expression, processing means for determining a sequence of mixture densities that has a minimum distance to the at least first sequence of feature vectors and storage means for storing an assignment between the speaker-dependent expression and the determined sequence of mixture densities.

In still another aspect, the invention provides a computer program product for training a speaker-independent speech recognition system with a speaker-dependent expression. The speech recognition system has a database that provides a set of mixture densities representing a vocabulary for a variety of training conditions. The inventive computer program product comprises program means that are operable to generate at least a first sequence of feature vectors of the speaker-dependent expression, to determine a sequence of mixture densities that has a minimum distance to the at least first sequence of feature vectors and to assign the speaker-dependent expression to the sequence of mixture densities.

Further, it is to be noted that any reference signs in the claims are not to be construed as limiting the scope of the present invention.

In the following preferred embodiments of the invention will be described in greater detail by making reference to the drawings in which:

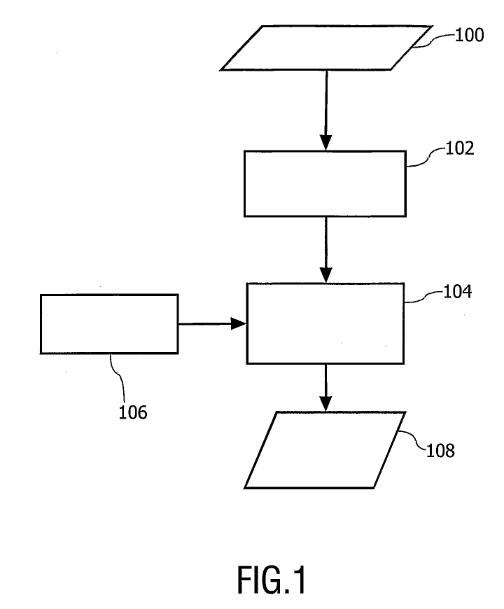

FIG. 1 shows a flow chart of a speech recognition procedure,

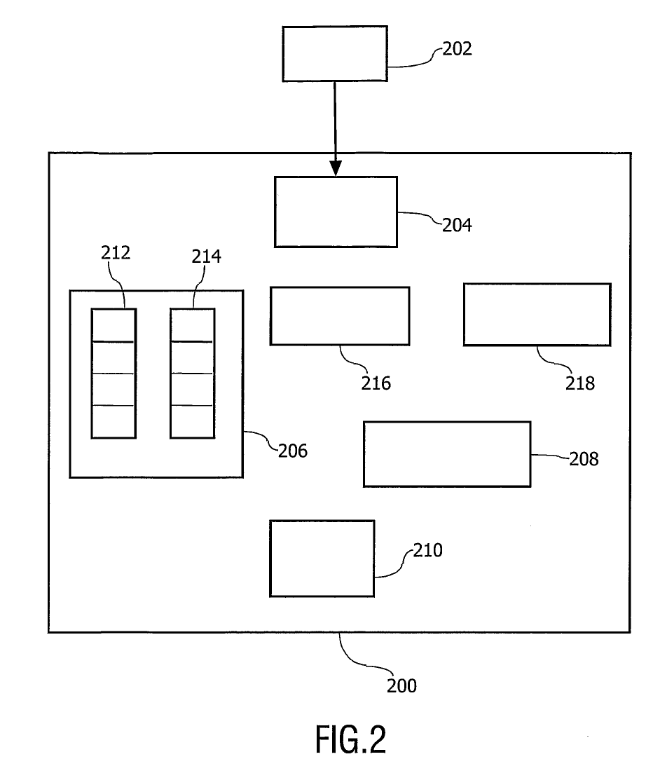

FIG. 2 shows a block diagram of the speech recognition system,

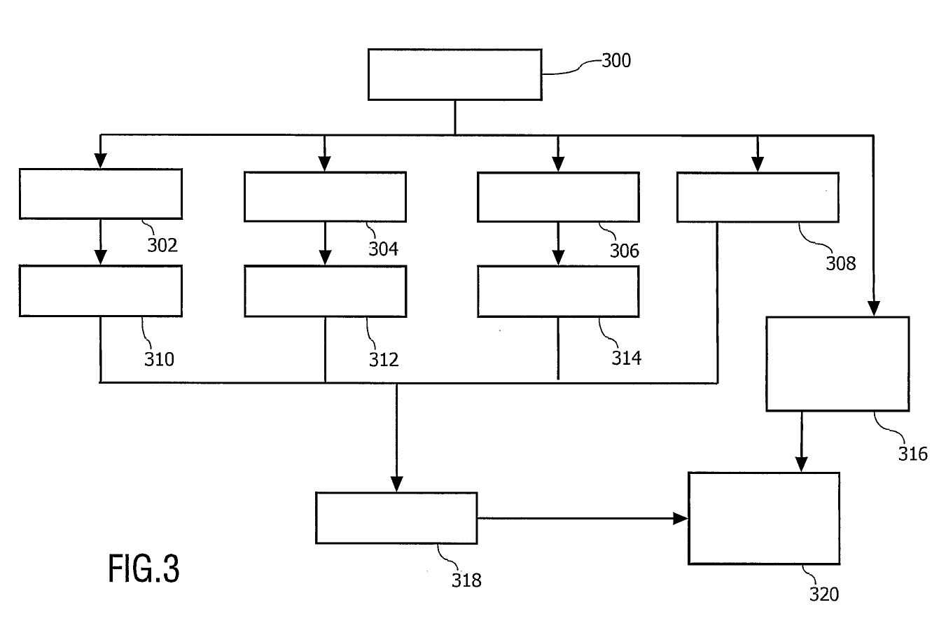

FIG. 3 illustrates a flow chart for generating a set of artificial feature vectors,

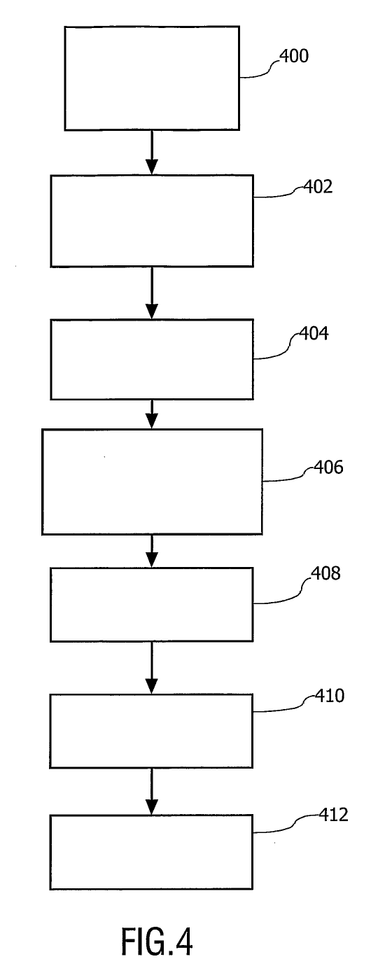

FIG. 4 shows a flow chart for determining the mixture density featuring a minimum score to a provided sequence of feature vectors.

FIG. 1 schematically shows a flow chart diagram of a speech recognition system. In a first step 100 speech is inputted into the system by means of some sort of recording device, such as a conventional microphone. In the next step 102, the recorded signals are analyzed by performing the following steps: segmenting the recorded signals into framed time windows, performing a power density computation, generating feature vectors in the log-spectral domain, performing an environmental adaptation and optionally performing additional steps.

In the first step of the signal analysis 102, the recorded speech signals are segmented into time windows covering a distinct time interval. Then the power spectrum for each time window is calculated by means of a Fast Fourier Transform (FFT). Based on the power spectrum, the feature vectors being descriptive on the most relevant frequency portions of the spectrum that are characteristic for the speech content. In the next step of the signal analysis 102 an environmental adaptation according to the present invention is performed in order to reduce a mismatch between the recorded signals and the reference signals extracted from training speech being stored in the system.

Furthermore additional steps may be optionally performed, such as a cepstral transformation. In the next step 104, the speech recognition is performed based on the comparison between the feature vectors based on training data and the feature vectors based on the actual signal analysis plus the environmental adaptation. The training data in form of trained speech references are provided as input to the speech recognition step 104 by the step 106. The recognized text is then outputted in step 108. Outputting of recognized text can be performed in a manifold of different ways, such as e.g. displaying the text on some sort of graphical user interface, storing the text on some sort of storage medium or by simply printing the text by means of some printing device.

FIG. 2 shows a block diagram of the speech recognition system 200. Here, the components of the speech recognition system 200 exclusively serve to support the signal analysis performed in step 102 of FIG. 1 and to assign speaker-dependent vocabulary words to pre-trained reference data. As shown in the block diagram of FIG. 2 speech 202 is inputted into the speech recognition system 200. The speech 202 corresponds to a speaker-dependent expression or phrase that is not covered by the vocabulary or by the pre-trained speech references of the speech recognition system 200. Further, the speech recognition system 200 has a feature vector module 204, a database 206, a processing module 208, an assignment storage module 210, an endpoint detection module 216 as well as an artificial feature vector module 218.

The feature vector module 204 serves to generate a sequence of feature vectors from the inputted speech 202. The database 206 provides storage capacity for storing mixtures 212, 214, each of which providing weighted spectral densities that can be used to represent speaker-independent feature vectors, i.e. feature vectors that are representative of various speakers and various environmental conditions of training data. The endpoint determination module 216 serves to identify those feature vectors of the sequence of feature vectors generated by the feature vector module 204 that correspond to a speech interval of the provided speech 202. Hence, the endpoint determination module 216 serves to discard those frames of a recorded speech signal that correspond to silence or to a speech pause.

The artificial feature vector generation module 218 provides generation of artificial feature vectors in response to receive a feature vector or a feature vector sequence from either the feature vector module 204 or from the endpoint determination module 216. Preferably, the artificial feature vector module 218 provides a variety of artificial feature vectors for those feature vectors that correspond to a speech interval of the provided speech 202. The artificial feature vectors generated by the artificial feature vector generation module 218 are provided to the processing module 208. The processing module 208 analyses the plurality of artificially generated feature vectors and performs a comparison with reference data that is stored in the database 206.

The processing module 208 provides determination of the mixture density of the mixtures 212, 214, that has a minimum distance or a minimum score with respect to one feature vector of the sequence of feature vectors generated by the feature vector module 204 or with respect to a variety of artificially generated feature vectors provided by the artificial feature vector generation module 218. Determination of a best matching speaker-independent mixture density can therefore be performed on the basis of the originally generated feature vector of the speech 202 or on the basis of artificially generated feature vectors.

In this way, a speaker-dependent vocabulary word provided as speech 202 can be assigned to a sequence of speaker-independent mixture densities and an explicit storage of speaker-dependent reference data can be omitted. Having determined a variety of mixture densities of the set of mixture densities featuring a minimum score with respect to the provided feature vector sequence, allows to assign the feature vector sequence to this variety of mixture densities. These assignments are typically stored by means of the assignment storage module 210. Compared to a conventional speaker-dependent adaptation of a speaker-independent speech recognition system, the assignment storage module 210 only has to store pointers between mixture densities and the speaker-dependent sequence of HMM states. In this way the storage demand for a speaker-dependent adaptation can be remarkably reduced.

Moreover, by assigning a speaker-dependent phrase or expression to speaker-independent reference data provided by the database 206, an environmental adaptation is inherently performed. A sequence of mixture densities of mixtures 212, 214 that are assigned to a feature vector sequence generated by the feature vector module 204 inherently represents a variety of environmental condition, such as different speakers, different signal to noise ratios, different speech velocity and different recording channel properties.

Moreover, by generating a set of artificial feature vectors by means of the artificial feature vector generation module 218, a whole variety of different environmental conditions can be simulated and generated, even though the speaker-dependent expression has been recorded in a specific environmental condition. By combining the plurality of artificial feature vectors and artificial feature vector sequences, the performance of the speech recognition process for varying environmental conditions can be effectively enhanced. Moreover, an assignment between a mixture density 212, 214 and a speaker-dependent expression can also be performed on the basis of the variety of the artificially generated feature vectors provided by the artificial feature vector module 218.

FIG. 3 is illustrative of a flow chart of generating a variety of artificial feature vectors. In a first step 300 a feature vector sequence is generated on the basis of the inputted speech 202. This feature vector generation of step 300 is typically performed by means of the feature vector module 204, alternatively in combination with the endpoint determination module 216. Depending on whether the endpoint determination is performed or not, the feature vector sequence generated in step 300 is either indicative of the entire inputted speech 202 or it represents the speech intervals of the inputted speech 202.

The feature vector sequence provided by step 300 is processed by various successive steps 302, 304, 306, 308 and 316 in a parallel way. In step 302, based on the original sequence of feature vectors, a noise and channel adaptation is performed by superimposing a first artificial noise leading to a first target signal to noise ratio. For instance, in step 302 a first signal to noise ratio of 5 dB is applied. In a similar way a second artificial feature vector with a second target signal to noise ratio can be generated in step 304. For example, this second target SNR equals 10 dB. In the same way steps 306 and 308 may generate artificial feature vectors of e.g. 15 dB and 30 dB signal to noise ratio, respectively. The method is by no means limited to generate only four different artificial feature vectors by the steps 302, . . . , 308. The illustrated generation of a set of four artificial feature vectors is only one of a plurality of conceivable examples. Hence, the invention may already provide a sufficient improvement when only one artificial feature vector is generated.

However, after steps 302 through 308 have been performed, a second set of steps 310, 312, 314 can be applied. Step 310 is performed after step 302, step 312 is performed after step 304 and step 314 is performed after step 306. Each one of the steps 310, 312, 314 serves to generate an artificial feature vector with a common target signal to noise ratio. For example, the three steps 310, 312, 314 serve to generate a target signal to noise ratio of 30 dB. In this way a single feature vector of the initial feature vector sequence generated in step 300 is transformed into four different feature vectors, each of which having the same target signal to noise ratio. In particular, the two-step procedure of superimposing an artificial noise in e.g. step 302 and subsequently de-noising the generated artificial feature vector allows to obtain a better signal contrast especially for silent passages of the incident speech signal. Additionally, the four resulting feature vectors generated by steps 310, 312, 314 and 308 can be effectively combined in the successive step 318, where the variety of artificially generated feature vectors is combined.

Additional to the generation of artificial feature vectors also an alignment to a Hidden-Markov-Model state is performed in step 316. This alignment performed in step 316 is preferably a linear alignment between a reference word and the originally provided sequence of feature vectors. Based on this alignment to a given HMM state, a mapping can be performed in step 320. This mapping effectively assigns the HMM state to a combination of feature vectors provided by step 318. In this way a whole variety of feature vectors representing various environmental conditions can be mapped to a given HMM state of the sequence of HMM states representing a speaker-dependent expression. Details of the mapping procedure are explained by means of FIG. 4.

The alignment performed in step 316 as well as the mapping performed in step 320 are preferably executed by the processing module 208 of FIG. 2. Generation of the various artificial feature vectors performed in steps 302 through step 314 is typically performed by means of the artificial feature vector module 218. It is to be noted that artificial feature vector generation is by no means restricted to such a two-step process as indicated by the successive feature vector generation realized by steps 302 and steps 310. Alternatively, also the feature vectors generated by steps 302, 304, 306 and 308 can be directly combined in step 318. Moreover, artificial feature vector generation is neither restricted to noise and channel adaptation. Typically, artificial feature vector generation can be correspondingly applied with respect to Lombard effect, speech velocity adaptation, dynamic time warping, . . . .

FIG. 4 illustrates a flow chart for determining a sequence of mixture densities of the speaker-independent reference data that has a minimum distance or minimum score to the initial feature vector sequence or to the set of artificially generated set of feature vector sequences. Here, in a first step 400 also a set of artificial feature vectors (i=1 . . . n) is generated that belong to an HMM state of the speaker-dependent expression. In a successive step 402 a probability P_{j,m,i} that feature vector Vᵢ can be generated by a density d_{j,m} of mixture mⱼ is determined. The index m denotes a density m of a mixture j. Hence, for each feature vector of the set of feature vectors a probability is determined that the feature vector can be represented by a density of a mixture. For instance, this probability can be expressed in terms of:

$$P ( {d}_{j , m} , {V}_{i} ) = C \cdot exp \{ {\sum }_{c} \{ abs \{ ( {V}_{i , c} - {d}_{j , m , c} ) / var [ c ] \} \} \} ,$$

where C is a fixed constant only depending on the variance of the feature vector components c and abs{ } represents the absolute value operation.

Thereafter, in step 404 the probability P_{j,i} that feature vector V, can be generated by mixture mⱼ is calculated. Hence, a probability is determined that the feature vector can be generated by a distinct mixture. Preferably, this calculation of P_{j,i} includes application of the Viterbi approximation. Hence, the maximum probability of all densities dm of a mixture mⱼ is calculated. This calculation may be performed as follows:

$$P ( j , {V}_{i} ) = {\sum }_{m} {P}_{j , m , i} \cdot {w}_{j , m} ,$$

where w_{j,m} denotes a weight of the m-th density in mixture j. By means of the Viterbi approximation the summation over probabilities can be avoided and replaced by the maximization operation max { . . . }. Consequently:

P(j,Vᵢ)=maxₘ{P_{j,m,i}·w_{j,m}}.

In a successive step 406 a probability Pⱼ that the set of artificial feature vectors belonging to a HMM state s can be generated by a mixture mⱼ is determined. Hence, this calculation is performed for all mixtures 212, 214 that are stored in the database 206. The corresponding mathematical expression may therefore evaluate to:

$${P}_{s} [ j ] = {( {\prod }_{i} {P}_{j , i , s } )}^{1 / n} ,$$

where i denotes an index running from 1 to n. It is to be noted that this sequence of feature vectors refers to an artificial set of feature vectors of a single initially obtained feature of the sequence of feature vectors. Making use of Gaussian and/or Laplacian statistics, it is advantageous make use of a negative logarithmic representation of the probabilities. In this way, an exponentiation can be effectively avoided, products in the above illustrated expressions turn into summations and a maximization procedure turns into a minimization procedure. Such a representation which is also referred to as distance d_{s,j} or score can therefore be obtained by:

d_{s,j}=−log Pₛ[j].

In the successive step 408 this minimization procedure is performed on the basis of the set of calculated d_{s,j}. The best matching mixture mⱼ′ then corresponds to the minimum score or distance. It is therefore the best choice of all mixtures provided by the database 206 to represent a feature vector of the speaker-dependent expression.

After having determined the best matching mixture mⱼ′ in step 408, this best mixture mⱼ′ is assigned to the HMM state of the speaker-dependent expression in step 410. The assignment performed in step 410 is stored by means of step 412, where a pointer between the HMM state of the user dependent expression and the best mixture mⱼ′ is stored by means of the assignment storage module 210.

1. A method of training a speaker-independent speech recognition system (200) with a speaker-dependent expression (202), the speech recognition system having a database (206) providing a set of mixture densities (212, 214) representing a vocabulary for a variety of training conditions, the method of training the speaker-independent speech recognition system comprising the steps of:
generating at least a first sequence of feature vectors of the speaker-dependent expression,
determining a sequence of mixture densities, having a minimum distance to the feature vectors of the at least first sequence of feature vectors,
assigning the speaker-dependent expression to the sequence of mixture densities.

2. The method according to claim 1, further comprising generating at least a second sequence of feature vectors of the speaker-dependent expression (202), the at least second sequence of feature vectors being adapted to match a different environmental condition than the first sequence of feature vectors.

3. The method according to claim 2, wherein generation of the at least second sequence of feature vectors is based on a set of feature vectors of the first sequence of feature vectors corresponding to a speech interval of the speaker-dependent expression.

4. The method according to claim 2, wherein the at least second sequence of feature vectors is generated by means of a noise adaptation procedure.

5. The method according to claim 2, wherein the at least second sequence of feature vectors is generated by means of a speech velocity adaptation procedure and/or by means of a dynamic time warping procedure.

6. The method according to claim 1, wherein the at least first sequence of feature vectors corresponds to a Hidden-Markov-Model (HMM) state of the speaker-dependent expression.

7. The method according to claim 1, wherein determining of the mixture density making use of a Viterbi approximation, providing a maximum probability that a feature vector of the at least first set of feature vectors can be generated by means of a mixture density of the set of mixture densities.

8. The method according to claim 1, wherein assigning the speaker-dependent expression to the mixture density comprising storing of a set of pointers pointing to the sequence of mixture densities.

9. A speaker-independent speech recognition system (200) having a database (206) providing a set of mixture densities (212, 214) representing a vocabulary for a variety of training conditions, the speaker-independent speech recognition system being extendable to speaker-dependent expressions (202), the speaker-independent speech recognition system comprising:
means for recording a speaker-dependent expression provided by the user,
means (204) for generating at least a first sequence of feature vectors of the speaker-dependent expression.
processing means (208) for determining a sequence of mixture densities having a minimum distance to the feature vectors of the at least first sequence of feature vectors,
storage (210) means for storing an assignment between the speaker-dependent expression and the sequence of mixture densities.

10. The speaker-independent speech recognition system (200) according to claim 9, further comprising means (218) for generating at least a second sequence of feature vectors of the speaker-dependent expression, the at least second sequence of feature vectors being adapted to simulate a different recording condition.

11. A computer program product for training a speaker-independent speech recognition system (200) with a speaker-dependent expression (202), the speech recognition system having a database (206) providing a set of mixture densities (212, 214) representing a vocabulary for a variety of training conditions, the computer program product comprising program means being operable to:
generate at least a first sequence of feature vectors of the speaker-dependent expression,
determine a sequence of mixture densities having a minimum distance to the feature vectors of the at least first sequence of feature vectors,
assign the speaker-dependent expression to sequence of mixture densities.
